(19) United States
(12) Patent Application Publication
(10) Pub. No.: US 2009/0031879 A1
(43) Pub. Date: Feb. 5, 2009

(54) Guitar/bass case with built-in tuner

(76) Inventor: Phillip Jason Everly, North Hollywood, CA (US)

Correspondence Address: TY UNG, 16830 VENTURA BLVD., SUITE 360, ENCINO, CA, 91436, US

(21) Appl. No.: 11/888,698

(22) Filed: Jul. 31, 2007

(51) Int. Cl. G10G 7/02

(52) U.S. Cl. 84/454

(57) ABSTRACT

This invention relates to a musical instrument case with a built-in tuner. The tuner gives a musician the ability to tune their instrument quickly without the need to carry a separate tuner or look for their tuner elsewhere.

### CROSS-REFERENCE TO RELATED APPLICATION

This application claims priority to provisional application No. 60/834,060 filed on Jul. 28, 2006.

### FEDERALLY SPONSORED RESEARCH

Not Applicable

### SEQUENCE LISTING OR PROGRAM

Not Applicable

### FIELD OF THE INVENTION

This invention relates to a musical instrument case with a built-in tuner. The tuner gives a musician the ability to tune their instrument quickly without the need to carry a separate tuner or look for their tuner elsewhere.

### BACKGROUND OF THE INVENTION

Tuners, such as chromatic tuners, as well as musical instrument cases individually are very common in the prior art. Tuners onboard the musical instrument itself are also previously described in U.S. Pat. No. 5,637,820 (Wittman, 1997); U.S. Pat. No. 5,877,444 (Hine et al 1999); and U.S. Pat. App. 2007006716 (Salmond et al, 2007). While tuners onboard the musical instrument is convenient for the owner of the musical instrument, it generally cannot be shared with other instrument users. Additionally, if a musician changes instrument, there is a need to buy either another tuner or buy another instrument with its own onboard tuner.

The present invention avoids the short falls of the prior arts by combining the tuner within a musical instrument case instead of placing the tuner onboard the instrument itself. As musicians often lose their tuners due to the fact that tuners are a separate piece from the instrument case, they cannot perform the tuning of their instrument prior to performing or practicing or may have to borrow a tuner from other musicians. Because the present invention combines the tuner and musical instrument case into one product, the tuner is never lost.

The present invention also avoids the need to buy an instrument with an onboard tuner or another tuner every time the musician changes instrument since the musician can reuse the musical instrument case of the present instrument with the new musical instrument. Furthermore, the musical instrument case of the present invention can also be used by other musicians because the tuner is separate from the musical instrument.

### BRIEF DESCRIPTION OF THE FIGURES

FIG. 1 is perspective view of the guitar/bass case with built-in chromatic tuner in accordance with the present invention.

FIG. 2 is plan view of the chromatic tuner in accordance with the present invention.

### FIGURES—REFERENCE NUMERALS

10 . . . Guitar/bass Case
12 . . . Chromatic Tuner
14 . . . Power Switch
16 . . . Input Socket
18 . . . Output Socket
20 . . . Display Panel
22 . . . Battery Compartment
24 . . . Higher Frequency Light
26 . . . Accurate Frequency Light
28 . . . Lower Frequency Light

### DETAILED DESCRIPTION

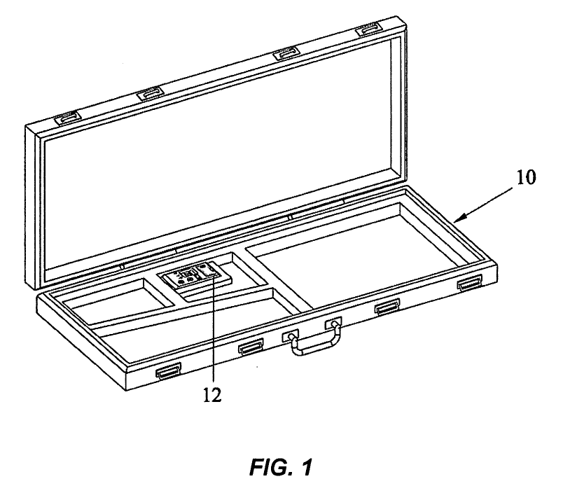

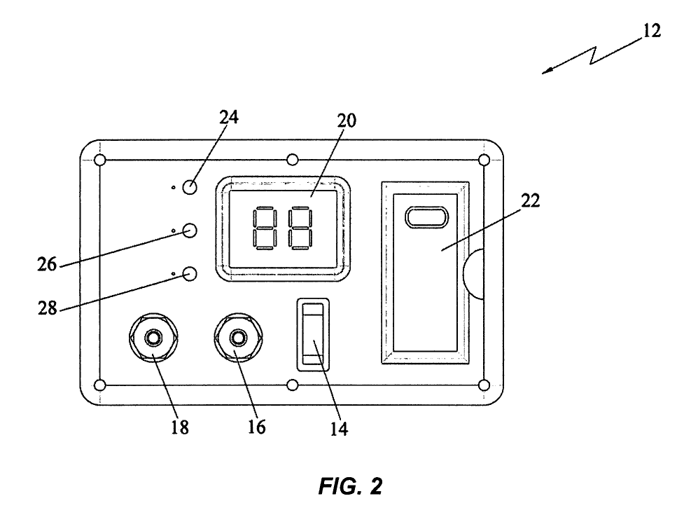

The novel features of the present invention will become apparent from the following description of a preferred embodiment of the invention and as illustrated in FIGS. 1 and 2. The present invention is a musical instrument case, such as a guitar or base case, with a built-in musical tuner, such as a chromatic tuner.

Referring to FIG. 1, the tuner 12, which is known in the industry, is permanently affixed to the interior of the case 10. Various methods for securing the tuner 12 known in the art may be used such as screws, a built in shell, or Velcro. The present invention shows a shell that is built around the tuner for holding the tuner 12 securely to the case.

Referring to FIG. 2, the tuner 12 may comprise a power switch 14, input 16 and output 18 sockets, a display panel 20, a battery compartment 22, and a plurality of frequency indicators 24, 26, and 28, all located on the top surface of the tuner so as to provide easy access for the musician. The power switch 14 activates and deactivates the tuner 12. The input 16 and the output 18 sockets receive the guitar/bass cord and an output cord respectively. The output cord in turn can be connected to an amplifier or a speaker. The display panel 20 displays the string number and the note name in juxtaposition. The plurality of frequency indicators 24, 26, and 28 comprises a higher frequency light 24, an accurate frequency light 26, and a lower frequency light 28 located one below another. The higher, accurate, and lower frequencies of a particular guitar string, when being plucked, are represented by the higher frequency light 24, accurate frequency light 26, and lower frequency light 28 respectively.

A battery compartment 22 is also provided for providing power to the tuner 12. The tuner 12 as shown shows the opening of the battery compartment 22 facing outward for ease of access to replace batteries. A battery compartment 22 may also be provided at the bottom of the tuner. Once the batteries are inserted into the battery compartment 22 and the tuner 12 activated, the guitar/bass input cord is plugged into the input socket 16 to tune the guitar/bass. The tuner 12 automatically identifies and displays the guitar/bass string number and the note name of the particular string being plucked. If the higher frequency light 24 blinks rapidly as a string is plucked, the string needs to be loosened until the rapid blinking rate gradually decreases to a slower blinking rate, and the slower blinking rate diminishes to activate the accurate frequency light 26, which denotes that the string is tuned. Similarly, if the lower frequency light 28 blinks rapidly, the string needs to be tightened until the rapid blinking rate gradually decreases to a slower blinking rate, and the slower blinking rate diminishes to turn on the accurate frequency light 26. However, if the string being plucked and the string number being displayed are not the same, the string needs to be tightened or loosened until the correct string number is displayed. To be more particular, the string needs to be tightened if the display panel 20 shows the string number to be greater than the string that is being plucked, and vice versa, following which the string needs to be tuned as mentioned earlier.

Alternatively, the tuner may be used without having to plug into the input socket 16 or output socket 18. The tuner of this type would sense the string or note being played and display an output to show that the note being played is accurate.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

While specific systems and methods have been disclosed in the preceding description, it should be understood that these specifics have been given for the purpose of disclosing the principles of the present invention and that many variations thereof will become apparent to those who are versed in the art.

1. A musical instrument case with a tuner.

2. The musical instrument case of claim 1, wherein the tuner is built-in.

3. The musical instrument case of claim 1, wherein the tuner further comprises an input jack and an output jack.

4. The musical instrument case of claim 1, wherein the tuner is secured to the instrument case with screws.

5. The musical instrument case of claim 1, wherein the tuner is secured to the case by a shell built to fit over the tuner.

6. The musical instrument case of claim 1, wherein the tuner has an automatic string number display.

7. The musical instrument case of claim 1, wherein the tuner has a note display.

8. The musical instrument case of claim 1, wherein the tuner has a higher frequency light.

9. The musical instrument case of claim 1, wherein the tuner has an accurate frequency light.

10. The musical instrument case of claim 1, wherein the tuner has a lower frequency light.

11. The musical instrument case of claim 1, wherein the tuner is a chromatic tuner.

12. The musical instrument case of claim 1, wherein the case is a guitar case.

13. The musical instrument case of claim 1, wherein the case is a bass case.

14. The musical instrument case of claim 12, wherein the tuner is a chromatic tuner.

15. The musical instrument case of claim 13, wherein the tuner is a chromatic tuner.

16. The musical instrument case of claim 1, wherein the tuner further comprises an input and output jack, an on and off switch, an automatic string number display, a note name display, higher frequency light, accurate frequency light, and lower frequency light.

17. The musical instrument case of claim 16, wherein the instrument case is a guitar case.

18. The musical instrument case of claim 16, wherein the instrument case is a bass case.

19. The musical instrument case of claim 17, wherein the tuner is a chromatic tuner.

20. The musical instrument case of claim 18, wherein the tuner is a chromatic tuner.

21. A method for using a musical instrument case with a built in tuner comprising the step of:
plugging in an input cord from a musical instrument into an input socket on said tuner;
turning on a power switch on said tuner, said tuner being housed in a musical instrument case;
playing a note on the said musical instrument;
checking a display on said tuner to determine when the correct note is played.
